(19) United States
(12) Patent Application Publication
(10) Pub. No.: US 2015/0081397 A1
(43) Pub. Date: Mar. 19, 2015

(54) DETERMINING THE PERFORMANCE OF A CONTENT NETWORK

(71) Applicant: Google Inc., Mountain View, CA (US)

(72) Inventor: Patrick Anthony Hummel, Cupertino, CA (US)

(73) Assignee: Google Inc., Mountain View, CA (US)

(21) Appl. No.: 14/026,942

(22) Filed: Sep. 13, 2013

(51) Int. Cl. G06Q 10/06; G06Q 30/08

(52) U.S. Cl. CPC G06Q 10/06375; G06Q 30/08
USPC 705/7.37

(57) ABSTRACT

Systems and methods for determining the performance of a content network include determining a differential performance for the network. A first performance metric for the content network may be determined for content auctions that the content network won. A second performance metric may also be determined that represents a performance metric based on predicted auction results that disregard the participation of the content network in the auctions. A differential performance metric for the content network may also be determined based on the difference between the first and second performance metrics.

### BACKGROUND

In some cases, the actual content presented to an online user includes a mix of first-party and third-party content. First-party content generally refers to the actual content requested by the user. For example, the user may request a first-party webpage by entering the network address of the webpage into his or her web browser and navigating to the webpage. A first-party content provider may also allow a third-party content provider to present content in conjunction with the first-party content. For example, a third-party advertisement may be presented in conjunction with a first-party webpage.

### SUMMARY

Implementations of the systems and methods for determining the performance of a content network are described herein. One implementation is a computerized method of determining a differential performance metric for a content network. The method includes retrieving, from a storage device, auction data indicative of results for a plurality of content auctions won by a first content network. The method also includes calculating, by one or more processors, a first performance metric for the first content network using the auction data. The method further includes generating, by the one or more processors, differential auction data from the auction data by disregarding the participation of the first content network in the plurality of content auctions won by the first content network. The method additionally includes determining a second performance metric for one or more other content networks by using the differential auction data to predict results for the content auctions that would have been won by the one or more other content networks had the first content network not participated in the content auctions. The method also includes determining a differential performance metric for the first content network by determining a difference between the first performance metric and the second performance metric.

Another implementation is a system for determining a differential performance metric for a content network. The system includes one or more processors operable to retrieve, from a storage device, auction data indicative of results for a plurality of content auctions won by a first content network. The one or more processors are also operable to calculate a first performance metric for the first content network using the auction data. The one or more processors are further operable to generate differential auction data from the auction data by disregarding the participation of the first content network in the plurality of content auctions won by the first content network. The one or more processors are additionally operable to determine a second performance metric for one or more other content networks by using the differential auction data to predict results for the content auctions that would have been won by the one or more other content networks had the first content network not participated in the content auctions. The one or more processors are also operable to determine a differential performance metric for the first content network by determining a difference between the first performance metric and the second performance metric.

A further implementation is a computer-readable storage medium having machine instructions stored therein that are executable by one or more processors and cause the one or more processors to perform operations. The operations include retrieving auction data indicative of results for a plurality of content auctions won by a first content network. The operations also include calculating a first performance metric for the first content network using the auction data. The operations additionally include generating differential auction data from the auction data by disregarding the participation of the first content network in the plurality of content auctions won by the first content network. The operations also include determining a second performance metric for one or more other content networks by using the differential auction data to predict results for the content auctions that would have been won by the one or more other content networks had the first content network not participated in the content auctions. The operations further include determining a differential performance metric for the first content network by determining a difference between the first performance metric and the second performance metric.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an implementation of a computer system, according to one example;

FIG. 2 is an illustration of an implementation of an electronic display showing an example first-party webpage including third-party content;

FIG. 3 is a detailed block diagram of the computer system of FIG. 1 in which content is exchanged, according to one implementation; and

FIG. 4 is an example flow diagram of one implementation of a process for determining the performance of a content network.

Like reference numbers and designations in the various drawings indicate like elements.

### DETAILED DESCRIPTION

According to some aspects of the present disclosure, a content publisher may allow another party, such as an advertiser, to include third-party content in conjunction with the publisher's first-party content. In doing so, the publisher may define a content space, i.e., where and how the third-party content is to be presented in relation to the first-party content. The third-party content may be directly integrated into the first-party content (e.g., appearing on the same webpage, appearing within a video game or other stand-alone application, etc.) or may be provided separately (e.g., appearing within a different window or tab as that of a webpage, when the webpage is loaded). For example, a content publisher that publishes an online news article may agree to allow a third-party advertiser to display a banner advertisement at the top of the news article. In return, the advertiser or other third-party content provider may compensate the website owner when the third-party content is presented to a visitor of the webpage.

First-party and third-party content providers may join various content networks, to facilitate the buying and selling of content spaces. For example, the owners of websites A, B, and C may join a first network of publishers (e.g., a network of first-party content providers) that offers to sell content spaces on their websites to third-party content providers, such as advertisers. Thus, a third-party content provider may be able to reach a larger audience by going through such a first-party centric content network. Similarly, third-party content providers, such as advertisers, may join a content network that is centered around the third-party content providers. For example, advertisers D, E, and F may join a second network of advertisers that operates to purchase content spaces.

In some implementations, a content exchange network may facilitate exchanges between publisher and third-party content networks. As used herein, a content exchange generally refers to the matching of third-party content to a content space associated with first-party content. For example, a content exchange service may allow different third-party content networks to compete to purchase content spaces from different first-party content networks. By analogy only, a content exchange network may operate in a similar manner to that of the stock market, with the various content networks acting as brokers for the content publishers and third-party content providers. In some implementations, the content exchange service may conduct an auction to select third-party content to be provided within a particular first-party content space.

The performance of a content network from the standpoint of a first-party content publisher or a third-party content provider may also be determined by the content exchange service. In some cases, a revenue per mille (RPM) score may be used to assess the performance of a content network in terms of revenues received by publishers of first-party content. An RPM score may be calculated, for example, by summing the revenues earned by the content publisher by the placement of content with the publishers' content, dividing the summed revenues by the number of queries in which content was placed, and multiplying by 1,000. Similarly, a value per mille (VPM) score may be used to assess the value provided by a publisher content network to third-party content providers (e.g., based on its winning auction bids). A VPM score may be calculated, for example, by summing the value a third-party content provider obtains for a particular content placement opportunity, divided by the number of queries in which the network won opportunities to place content with the publisher content network, and multiplying by 1,000. A content exchange service may use RPM and VPM scores for purposes of reporting (e.g., to notify a first or third party content provider as to the performance of a given content network) and/or determining which content networks are eligible to participate in auctions (e.g., low-performing content networks may be prevented from participating in auctions for certain content or even participating in the exchange entirely).

In some cases, RPM and VPM scores may not be reflective of the overall performance of a content network from the standpoint of a first or third-party content provider. For example, consider a set of auctions in which half of the winning bids are $2 for one type of first-party content and the other half of the winning bids are $1 for another type of first-party content. If a content network increases its bids for the first type of content to $2.01 and decreases its bids to $0.99 for the other type of content, it will win the auctions for the first type of content and lose the auctions for the second type of content. In such a case, the content network will have a VPM around $2. If the content network instead decreases its bids for the first type of content to $1.99 and increases its bids for the other type of content to $1.01, it will lose the auctions for the first type of content and win the auctions for the second type of content. In this case, the content network will have a VPM around $1. Even though the net effect on the exchange is the same in both cases (i.e., the content network increases its bids for one type by $0.01 and decreases its bids for another type by $0.01), the content network may be penalized for having a lower VPM score in the second scenario.

According to various implementations, the performance of a content network in a content exchange may be determined by calculating a differential performance metric. Such a metric may be based on predicted auction results for auctions won by a content network that disregard the participation of the content network in the auction. For example, if the winning bid from a content network is $0.01 greater than that of the next highest bid, the differential performance of the network in the auction may also be $0.01, regardless of the winning bid amount. In some cases, a differential performance metric for a content network may even be negative. For example, assume that a content network wins an auction in which the network agrees to pay a certain amount if a placed advertisement is clicked by a user (e.g., the advertisement is a cost per click advertisement) and that the user does not click on the advertisement. Thus, the value and revenue associated with the content network is actually zero, since the user never clicked on the advertisement and no exchange of money took place. Now, assume that another content network on the content exchange had attempted to place an impression-based advertisement in the same location as the cost per click advertisement (e.g., the content publisher is compensated for the placement itself, regardless of whether or not the user clicks on the advertisement). The amount the impression-based advertiser would have paid may be treated as lost revenues in calculating the differential performance metric, potentially leading to a negative differential performance metric for the content network.

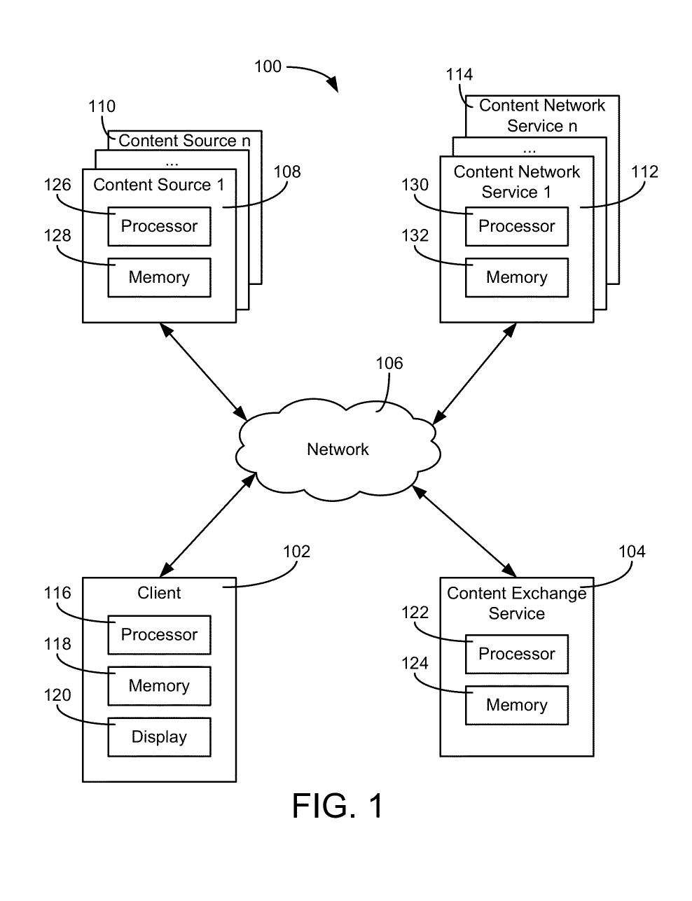

Referring to FIG. 1, a block diagram of a computer system 100 in accordance with a described implementation is shown. System 100 includes a client 102 which communicates with other computing devices via a network 106. Client 102 may execute a web browser or other application to receive content from other devices over network 106. For example, client 102 may communicate with any number of content sources 108-110 (e.g., a first content source through nth content source). Content sources 108-110 may provide webpage data and/or other content (e.g., a text document, a downloadable application, an advertisement, search results, or another form of content) to client 102. In some implementations, computer system 100 may also include any number of content network services 112-114 (e.g., a first content network service through nth content network service). Content sources 108-110 may belong to various content networks via content network services 112-114, either as first-party or third-party content providers. For example, content source 108 may serve a webpage to client 102 that includes an advertisement from content source 110 and selected via content network service 112. According to various implementations, system 100 may also include content exchange service 104, which is configured to allow content to be exchanged across the various content networks provided by content network services 112-114.

As used herein, first-party content refers to the primary online content requested or displayed by a client device, such as client 102. For example, first-party content may be a webpage requested by a web browser of client 102 or other content requested by client 102 for presentation in a stand-alone application (e.g., a video game, a chat program, a navigation program, etc.) running on client 102. For example, client 102 may access online game content from content source 108 via a game application executed by client 102. Third-party content, in contrast, refers to additional content that may be provided in conjunction with the first-party content. For example, third-party content may be an advertisement that appears in conjunction with a requested webpage (e.g., a search result webpage from a search engine, a webpage that includes a news article, etc.) or within a stand-alone application (e.g., a banner advertisement within a game application on client 102).

Network 106 may be any form of computer network that relays information between client 102, content sources 108-110, content network services 112-114, and content exchange service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 116 and a memory 118. Memory 118 may store machine instructions that, when executed by processor 116 cause processor 116 to perform one or more of the operations described herein. Processor 116 may include one or more microprocessors, ASICs, FPGAs, etc., or combinations thereof. Memory 118 may include, but is not limited to, electronic, optical, magnetic, or any other storage or transmission device capable of providing processor 116 with program instructions. Memory 118 may include a floppy disk, CD-ROM, DVD, magnetic disk, memory chip, ROM, RAM, EEPROM, EPROM, flash memory, optical media, combinations thereof, or any other suitable memory from which processor 116 can read instructions.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 120, which displays webpages and other data received from content sources 108-110, content network service 112-114, and/or content exchange service 104.

Content sources 108-110 may be one or more electronic devices connected to network 106 that provide content to client 102. For example, content sources 108-110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, an image file, an advertisement, a video game, a movie, or other forms of electronic content. The content provided by content sources 108-110 may be first-party content or third-party content, according to various implementations. For example, content source 108 may provide a first-party webpage to client 102 that includes third-party content from content source 110. Similar to client 102, content sources 108-110 may include processors and memories storing instructions that, when executed by their respective processors, cause the processors to perform the operations described herein. For example, content source 108 may include a processor 126 that executes instructions stored in a memory 128 that cause processor 126 to provide content to client 102.

According to various implementations, content sources 108-110 may provide webpage data to client 102 that includes one or more content tags. In general, a content tag may be any piece of webpage code associated with including content with a webpage. According to various implementations, a content tag may define a content space on a webpage for third-party content, a content space for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 108-110, content network services 112-114, content exchange service 104, etc.), a network location (e.g., a URL) associated with selecting the third-party content, how the third-party content is to be rendered on a display, one or more keywords used to retrieve the third-party content, and other functions associated with providing third-party content with a first-party webpage. For example, content source 108 may provide webpage data that causes client 102 to request third-party content from content network service 112. In another implementation, the third-party content may be selected by content network service 112 and provided by content source 108 as part of the webpage data sent to client 102.

Similar to content sources 108-110, content network services 112-114 may be one or more electronic devices connected to network 106 that facilitate providing third-party content from a content source (e.g., content source 110) with first-party content from another content source (e.g., content source 108). In some implementations, content network services 112-114 may process a request for third-party content from client 102 and select the third-party content to be provided to client 102. For example, a first-party webpage served by content source 108 may include a content tag that causes client 102 to request third-party content from content network service 112. In response to the request, content network service 112 may select third-party content from content source 110 to be provided with the webpage from content source 108. Content network services 112-114 may each include one or more processors that execute instructions stored in one or more memories. For example, content network service 112 may include a processor 130 that executes instructions stored in memory 132 that cause content network service 112 to perform the operations described herein.

According to various implementations, content network services 112-114 may communicate with content exchange service 104 to facilitate the selection of third-party content to be provided with first-party content. For example, assume that content source 108 provides first-party content and participates in the content network maintained by content network service 112. Also, assume that content source 110 provides third-party content and participates in a different content network maintained by content network service 114. In such a case, content network service 112 may provide an indication to content exchange service 104 that content space is available for the first-party content provided by content source 108. Similarly, content network service 114 may provide a request to content exchange service 104 to include the third-party content from content source 110 in the content space. Thus, third-party content from content source 110 may be included with first-party content from content source 108, even though the two content sources are in different content networks. In some implementations, content exchange service 104 may conduct an auction, allowing different third-party content providers and/or third-party content provider networks to compete for the ability to include third-party in a content space of first-party content.

Content exchange service 104 may be a computer server (e.g., FTP servers, file sharing servers, web servers, etc.) or a combination of servers (e.g., a data center, a cloud computing platform, etc.). Content exchange service 104 may include a one or more processors 116 and a memory 122 (e.g., one or more storage devices) that stores program instructions executable by processor 116. In some implementations, content exchange service 104 may be configured to conduct an auction to select third-party content to be provided to client 102. For example, content exchange service 104 may select content, such as an advertisement, to be provided with a webpage served by content source 108 or 110. In cases in which content exchange service 104 is a combination of computing devices, processor 116 may represent the collective processors of the devices and memory 122 may represent the collective memories of the devices.

Third-party content selected by content exchange service 104 may be provided to client 102 by content sources 108-110, content network services 112-114, or by content exchange service 104 itself. For example, content exchange service 104 may select third-party content from content source 110 to be included with a first-party webpage served by content source 108. In another example, content exchange service 104 may provide the selected content to client 102 directly. In some implementations, content exchange service 104 may select third-party content already stored in memory 118 of client 102. For example, previously provided third-party content may be cached in memory 118, third-party content may be preloaded into memory 118 (e.g., as part of the installation of an application), or may exist as part of the operating system of client 102. In such a case, content exchange service 104 may provide an indication of the selection to client 102. In response, client 102 may retrieve the selected third-party content from memory 118 and display it on display 120 in conjunction with first-party content.

In some implementations, content exchange service 104 and/or content network services 112-114 may be configured to select third-party content based on a device identifier associated with client 102. In general, a device identifier refers to any form of data that may be used to represent a device or a particular software program executed by the device. Device identifiers may include, but are not limited to, cookies, device serial numbers, user profile data, telephone numbers, network addresses, identifiers generated using hardware or software serial number, or the like. For example, a device identifier associated with client 102 may be used to identify client 102 to content exchange service 104.

For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected and presented to the user. Certain data, such as a device identifier, may be anonymized in one or more ways before it is stored or used, so that personally identifiable information is removed when generating parameters (e.g., demographic parameters) used in system 100 to select third-party content. For example, a device identifier for client 102 may be anonymized so that no personally identifiable information about its corresponding user can be determined from it. In another example, a user's geographic location may be generalized where location information is obtained (such as to a city, ZIP code, or state level), so that a precise location of the user cannot be determined. Thus, the user of client 102 may have control over how information is collected about him or her and used in system 100 to select third-party content for client 102.

In some implementations, content exchange service 104 and/or content network services 112-114 may analyze history data associated with a device identifier to determine one or more potential interest categories associated with the device identifier. History data may be any data associated with a device identifier that is indicative of an online action (e.g., visiting a webpage, selecting an advertisement, navigating to a webpage, making a purchase, downloading content, etc.). For example, a device identifier associated with a number of visits to webpages devoted to golf may be associated with the interest category of golf. Advertisers and other third-party content providers that have content matching an interest category of a device identifier may compete in a content auction conducted by content exchange service 104 to select content to be provided to a device associated with the device identifier. For example, content exchange service 104 may select third-party content to be displayed with a certain first-party webpage by client 102.

According to various implementations, one or more of the devices in system 100 may be configured to determine a performance metric associated with any of the content networks provided by content network services 112-114. For example, content exchange service 104 may determine an RPM value that represents a measure of the amount of revenues content source 108 receives from the content network of content network service 112 via the content exchange. In some implementations, a differential performance metric may be determined for a content network. The differential performance metric may be based in part on a first performance metric calculated using auction results for content auctions won by the content network, differential auction data that disregards the participation of content network in the auctions, and a second performance metric calculated using the differential auction data. For example, the differential performance metric for the content network may be the average difference between the two performance metrics, the cumulative difference between the two performance metrics, or another combination thereof.

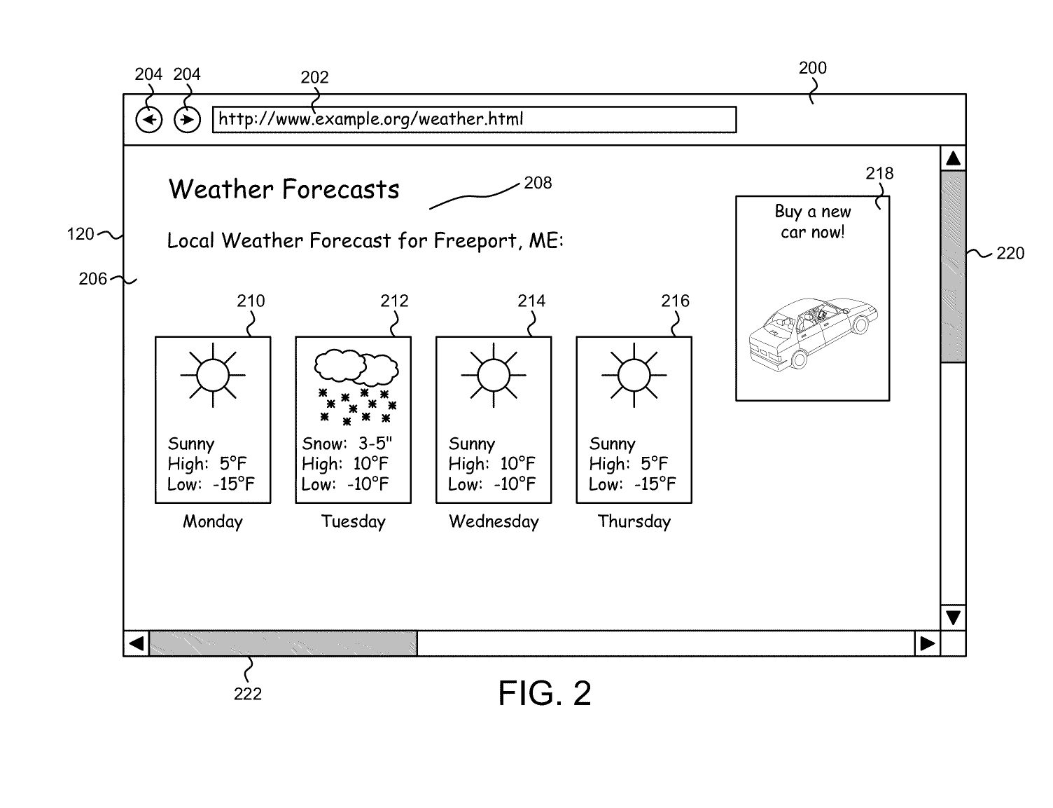

Referring now to FIG. 2, an illustration is shown of electronic display 120 displaying an example first-party webpage 206 including third-party content 218. Electronic display 120 is in electronic communication with processor 116 which causes visual indicia to be displayed on electronic display 120. For example, processor 116 may execute a web browser 200 or other application stored in memory 118 of client 102 to display content received by client 102 via network 106. In various implementations, electronic display 120 may be located inside or outside of the same housing as that of processor 116 and/or memory 118. For example, electronic display 120 may be an external display, such as a computer monitor, television set, or any other stand-alone form of electronic display. In other examples, electronic display 120 may be integrated into the housing of a laptop computer, mobile device, or other form of computing device having an integrated display.

As shown, web browser 200 may operate by receiving input of a uniform resource locator (URL) or other network address via an input field 202. The input may be received from any form of electronic input device in communication with processor 116 (e.g., a pointing device, a keyboard, a touchscreen, etc.). Processor 116 may use the inputted URL to request data from a content source having a network address that corresponds to the entered URL. For example, processor 116 may request the file, weather.html, from content source 108 via network 106. In response, the content source may return webpage data (e.g., the file, weather.html) and/or other data to client 102. Web browser 200 may utilize the received webpage data to then render a webpage 206 on electronic display 120.

In general, webpage data may include text, hyperlinks, layout information, and other data that may be used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. The webpage data may include data that specifies where indicia appear on webpage 206, such as text 208. In some implementations, the webpage data may also include additional URL information used by the client device to retrieve additional indicia displayed on webpage 206. For example, the file, “weather.html,” may also include one or more instructions used by processor 116 to retrieve images 210-216 from a content source.

Web browser 200 may include a number of navigational controls. For example, web browser 200 may include inputs 204 (e.g., a back button, a forward, button, etc.) configured to cause browser 200 to alternate between previously visited webpages. Web browser 200 may also include one or more scroll bars 220, 222 which are configured to cause the display of portions of webpage 206 that may be currently off-screen. For example, webpage 206 may be formatted to be larger than the screen of electronic display 120. In such a case, the one or more scroll bars 220, 222 may be used to change the vertical and/or horizontal position of webpage 206 on electronic display 120.

Webpage 206 may include first-party content, such as text, images, or other forms of indicia to convey information to a user of client 102. For example, text 208 may indicate that webpage 206 provides information about the weather forecast for Freeport, Me. Similarly, images 210-216 may provide information about the latest weather forecast. For example, image 210 may indicate that the weather is predicted to be sunny on Monday, while image 212 may indicate that snow is predicted for Tuesday. Any combination of text, images, and/or other files may be used by webpage 206 to convey information to a user. For example, the weather forecast for Tuesday may be conveyed via text, instead of via image 212.

According to various implementations, first-party webpage 206 may also include third-party content 218 (e.g., content provided by a different source than that of webpage 206). For example, one or more content tags may be embedded into the webpage code located in the file “weather.html” and/or in other files of webpage 206. In one example, “weather.html” may include a content tag that specifies that a content field is to be located at the position of third-party content 218 (i.e., a defined content space on webpage 206). Another content tag may cause processor 116 to request third-party content, such as an advertisement, from a content network service (e.g., content network service 112), when webpage 206 is loaded. Such a request may include one or more keywords, a device identifier for client 102, or other data used by content network service 112 to select which third-party content is to be provided to client 102. Content network service 112 may itself select the third-party content from a content source that participates in its content network or may request third-party content from a content exchange service, such as content exchange service 104. The selected third-party content may then be provided to client 102 by content network service 112, content exchange service 104, or a content source (e.g., content source 110). In other cases, content network service 112 may send a command to client 102 that causes client 102 to retrieve third-party content 218 from a local memory or from a networked content source. In this way, any number of different pieces of third-party content may be placed in the location of third-party content 218 on webpage 206. In other words, one user that visits webpage 206 may be presented with third-party content 218 and a second user that visits webpage 206 may be presented with a different advertisement.

In other implementations, client 102 may execute a stand-alone application that is configured to perform similar actions as web browser 200 when webpage 206 is loaded. For example, client 102 may execute a stand-alone game program, chat program, email program, navigation program, or the like. The stand-alone application may provide first-party content that is part of the application to display 120. Similar to web browser 200, the stand-alone application may also cause client 102 to request third-party content to be provided in conjunction with the stand-alone application. For example, a video game executed by client 102 may periodically request a third-party advertisement from a content network service to be displayed as a banner advertisement with the game.

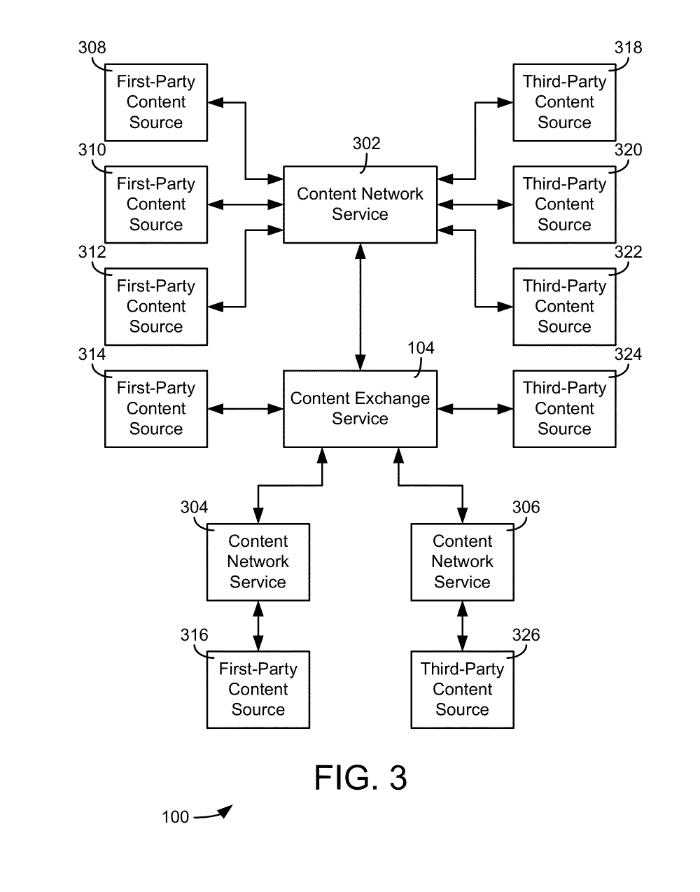

Referring now to FIG. 3, a detailed block diagram of computer system 100 is shown in which content is exchanged, according to one implementation. As shown in FIG. 3, content network services 112-114 shown in FIG. 1 may include content network services 302-306. Also as shown in FIG. 3, content sources 108-110 shown in FIG. 1 may include first-party content sources 308-316 and third-party content sources 318-326.

In various implementations, content exchange service 104 may manage content exchange transactions across the various devices in system 100. In general, a content exchange transaction refers to any transaction in which third-party content is matched to a content space associated with first-party content. In some implementations, content exchange service 104 may be configured to conduct an auction in which various participants in system 100 compete to match third-party content with first-party content spaces. For example, third-party content from content source 322 may be matched to a content space associated with first-party content from content source 310 via an auction conducted by content exchange service 104. In such a case, content network service 302 may broker the transaction between the two devices. For example, content source 322 may provide third-party content and an auction bid to content exchange service 104 via content network service 302. If content exchange service 104 determines the auction bid to be the winner, the third-party content from content source 322 may be provided to a client device with the first-party content from content source 318.

Since system 100 is not limited to exchanges within a single content network, some participating content networks may include only third-party content sources or first-party content sources. For example, a third-party centric content network may be managed by content network service 306 and include third-party content source 326 (e.g., content network service 306 only participates in the content exchange on behalf of third-party content sources). Similarly, a first-party centric content network may be managed by content network service 304 and include first-party content source 316 (e.g., content network service 304 only participates in the content exchange on behalf of first-party content sources). Content network service 304 may provide an indication of content space availability to content exchange service 104. Similarly, content network service 306 may provide an indication to content exchange service 104 of the type of third-party content (e.g., one or more topical categories for the content) and a bid or other monetary amount for the ability to include the third-party content with a first-party content space.

In some implementations, a first or third-party content source may participate directly with content exchange service 104. For example, first-party content source 314 may be a well-known website and third-party content source 324 may be a prolific advertiser. In such cases, content sources 314, 324 may forego the use of a content network as an intermediary in a content exchange transaction (e.g., by interacting directly with content exchange service 104).

According to various implementations, content exchange service 104 may conduct an auction in which a bid is placed for the ability to include third-party content within a first-party content space. In various implementations, bids may be based in part on topical categories for the third-party content. For example, a third-party advertisement may be related to the topical category of automobiles. In some implementations, a bid may be further based on a topical category associated with the first-party content. For example, a webpage having an associated content space may be related to reviews of automobiles. In such a case, a bid may be placed in the auction for the ability to include the third-party advertisement for an automobile on the webpage devoted to reviews of automobiles.

Content exchange service 104 may store auction data regarding the results of content exchange transactions. The auction data may include, for example, data regarding the bid amounts placed by any of content network services 302-306 and/or content sources 314, 324, the type of third-party content associated with the bids (e.g., whether the third-party content is impression-based, click-based, etc.), the identity of the bidders, results of the content placement (e.g., whether the placed content was clicked, whether a conversion resulted, etc.), or any other data regarding the results of a content auction. In various implementations, content exchange service 104 or another device in system 100 may use the stored auction data to determine a performance metric for any of content network service 302-306 in terms of the value or revenue the network service provides.

According to one implementation, differential auction data may be determined using the auction data from content exchange service 104 to predict auction results that would have occurred had the winning content network not participated in the auction. The differential auction data may also be used to determine a second performance metric, such as the revenue that a first-party content provider would have received from the auction had the winning content network not participated in the auction. In various implementations, a differential performance metric may be calculated for a content network based on the performance metric calculated using the actual results of an auction won by the network and the second performance metric calculated using the predicted auction results that disregard the participation of the network in the auction.

In one example, let Q represent the total number of auctions that content network service 306 attempts to win, let q denote the number of auctions content network service 306 actually wins, let V represent the average VPM would be in all Q auctions if the content network did not participate in any auctions, let v̅ represent the average VPM in the q auctions won by content network service 306, let v̅_{q} represent the average VPM in the q auctions had the content network service 306 not attempted to win any of these auctions, and let v̅_{Q-q} denote the average VPM in the Q−q auctions that content network service 306 did not win. Thus, the total efficiency for system 100 is q v̅+(Q−q) v̅_{Q-q} and that, by definition, QV=q v̅_{q}+(Q−q) v̅_{Q-q}. Therefore, QV−q v̅_{q}=(Q−q) v̅_{Q-q} and the total efficiency is QV+q v̅−q v̅_{q}. Since v̅_{q}, v̅, and q can be obtained from the auction data from content exchange service 104, a differential VPM performance metric for content network service 306 may be equal to q( v̅− v̅_{q}), according to various implementations. In other words, v̅ is a first performance metric (e.g., an average VPM) for content network service 306 calculated using actual auction results won by service 306 and v̅_{q} is a second performance metric (e.g., another average VPM) calculated using differential auction data in which the participation of content network service 306 is disregarded. In some implementations, the differential performance metric may be calculated by determining the difference between the actual value realized and the threshold content network service 306 had to overcome to win each auction and summing these results.

In another example, let Q represent the total number of auctions that content network service 306 attempts to win, let q denote the number of auctions content network service 306 actually wins, let R represent the average RPM would be in all Q auctions if the content network did not participate in any auctions, let r̅ represent the average RPM in the q auctions won by content network service 306, let r̅_{q} represent the average RPM in the q queries had the content network service 306 not attempted to win any of these auctions, and let r̅_{Q-q} denote the average RPM in the Q−q auctions that content network service 306 did not win. Thus, the total revenue in system 100 is q r̅+(Q−q) r̅_{Q-q} and that, by definition, QR=q r̅_{q}+(Q−q) r̅_{Q-q}. Therefore, QR−q r̅_{q}=(Q−q) r̅_{Q-q} and the total revenue is QR+q r̅−q r̅_{q}. According to various implementations, a differential RPM performance metric for content network service 306 may be calculated as q( r̅− r̅_{q}). In other words, r̅ is a first performance metric (e.g., an average RPM) for content network service 306 calculated using actual auction results won by service 306 and r̅_{q} is a second performance metric (e.g., another average RPM) calculated using differential auction data in which the participation of content network service 306 is disregarded.

A differential performance metric may be used in system 100 in a number of different ways. In one implementation, a differential performance metric calculated by content exchange service 104 or another device in system 100 may be included in a report generated by the device. For example, content exchange service 104 may provide an online utility that allows a first-party content publisher, such as content source 314, to review the differential RPM of content network services 302-306. In another implementation, content exchange service 104 may use a differential performance metric for any of content network service 302-306 for purposes of changing how auctions are conducted (e.g., to optimize the value/revenue that result from the content exchange). In yet another implementation, content exchange service 104 may automatically adjust how content auctions are conducted based on one or more differential performance metrics for any of content network service 302-306. For example, a content network having a low differential VPM and/or RPM may be prevented by content exchange service 104 from winning a given auction or participating in a content exchange transaction.

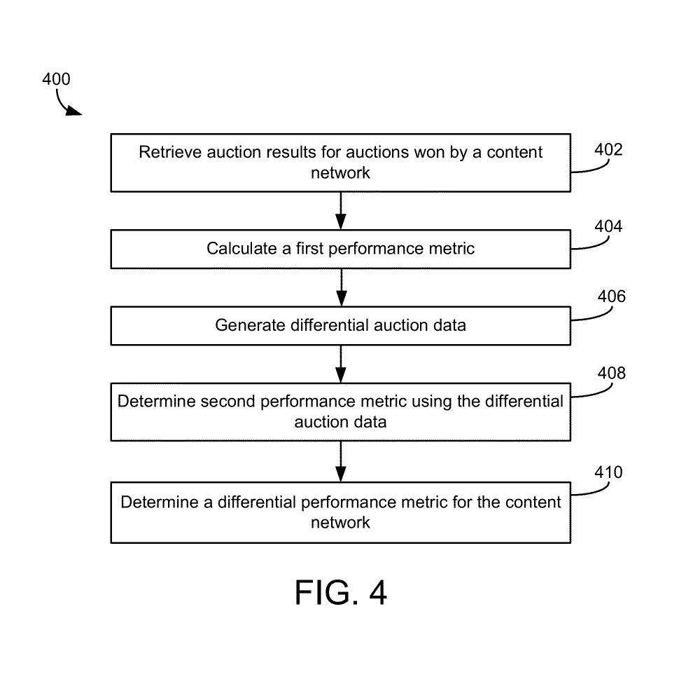

Referring now to FIG. 4, an example flow diagram of one implementation of a process 400 for determining the value of a content network is shown. Process 400 includes retrieving auction results for auctions won by a content network (step 402), calculating a first performance metric using the retrieved auction results (step 404), generating differential auction data that disregards the participation of the content network (step 406), determining a second performance metric using the differential auction data (step 408), and determining a differential performance metric for the content network (step 410). Process 400 may be implemented by one or more computing devices, such as by content exchange service 104 shown in FIGS. 1 and 3, or by another computing device in communication therewith. In general, process 400 allows the value, revenue, etc. of a content network participating in a content exchange to be evaluated.

Still referring to the implementation of FIG. 4, process 400 includes retrieving auction results for auctions won by a content network (step 402). For example, content exchange service 104 shown in FIG. 3 may store and retrieve data regarding a content exchange auction to evaluate the performance of the content network that won the auctions. Auction result data may include, but is not limited to, data identifying the auction participants, the bid amounts of the auction participants (e.g., the winning bid amounts from the content network and any other bid amounts), the types of third-party content corresponding to the auction bids (e.g., whether the bid represents an amount of money to be paid for an impression, click, etc.), the type of first-party content with which the third-party content was presented, the types of content spaces associated with the first-party content (e.g., banner placements, below the fold placements, pop-up placements, etc.), or any other information regarding the results of a content auction. In some case, data regarding events that resulted at a client device may also be included in the auction result data. For example, clicking on an advertisement selected by the system may cause the client device to report the click, which may be recorded in conjunction with the other auction results.

The auction result data retrieved for the content network may be from any time period. For example, the auction result data may be from the current day, the previous day, the previous week, the previous month, the previous year, another time period, combination of time periods (e.g., auction result data from Mondays, auction result data from the month of August, etc.), or the entire historical period over which the auction data is available. In some cases, one or more parameters may be used to specify the time period for the auction result data to control over which time period the differential performance metric is calculated for the content network.

Yet still referring to the implementation of FIG. 4, process 400 includes calculating a first performance metric for the content network based on the retrieved auction results (step 404). In one implementation, the performance metric is a value metric that represents the value a third-party content provider obtained by winning a content auction. For example, a value metric may correspond to an amount of money an advertising opportunity is actually worth to an advertiser. In another implementation, the performance metric is a revenue metric that represents the amount of revenue that a first-party content provider received as a result of the content network winning the auction. For example, a revenue metric may correspond to an amount of money received by a first-party content provider in response to the placement of an advertisement with the provider's content, in response to a user clicking on the placed advertisement (e.g., a click-through advertisement), or the like. In various implementations, the performance metric may be on a per-auction basis or across all auctions won by the content network in the retrieved auction data. In one implementation, the performance metric may be based on an average of metrics across the auctions that were won by the content network. For example, an RPM or VPM value may be calculated for the content network based on the retrieved auction result data.

Referring still to the implementation of FIG. 4, process 400 includes generating differential auction data (step 406). In general, differential auction data refers to the auction result data that disregards the participation of the content network in an auction. For example, differential auction data may include information regarding the auction bids placed by other content networks or providers that did not win a content auction. The differential auction data may also include any other information related to the losing bidders. For example, the differential auction data may include information regarding the types of content (e.g., impression-based, click-through, etc.), and any other information regarding the auctions.

Referring yet still to the implementation of FIG. 4, process 400 includes determining a second performance metric using the differential auction data (step 408). In some implementations, the differential auction data may be used to predict results for the content auctions had the winning content network not participated in the auctions. For example, the service may predict that another content network would have won the auction by having the second highest bid in the auction. The system may also predict the net effect of a different content network winning the auction. For example, the revenues that would have been earned by first-party content publisher may be estimated (e.g., based on a bid for an impression, based in part on an estimated click through rate for the content from the network that would have won the auction, etc.). Similar to the performance metric determined in step 404, the second performance metric may correspond to a value score, a revenue metric, or the like. In various implementations, the performance metric may determined on a per-auction basis or aggregated across the auctions under study. For example, the second performance metric may be an average of metrics for the set of auctions under study or based on such an average (e.g., an RPM score, a VPM score, etc.).

Referring still to the implementation of FIG. 4, process 400 includes determining a differential performance metric for the content network (step 410). In various implementations, the differential performance metric may be calculated based on a difference between the performance metric determined in step 404 and the second performance metric determined in step 406. For example, assume that a content network wins a content auction with a bid of $2 to place an advertisement on a first-party webpage on a cost per click basis (e.g., the advertiser is willing to pay $2 if the user clicks on the advertisement). Also, assume that the next highest bid in the auction was $1.99. In such a case, the differential value associated with the content network's bid is $0.01. In some implementations, a differential performance metric may be determined on a per auction basis and the performance metrics may be aggregated across the network's auctions. For example, the overall performance metric for a content network may be the average differential performance metric across any number of content auctions.

The differential performance metric calculated via process 400 may be used in a number of ways, according to various implementations. In one implementation, the differential performance metric for a content network may be included in a report. Such a report may be used internally by the content exchange service, sent to a content provider, or may even be reported to the content network itself. In further implementations, the differential performance metric determined via process 400 may be used by the content exchange service to control whether the corresponding content network is eligible to participate in a given content auction. For example, a content provider may specify that a content network that has a negative differential performance metric may not be eligible to place content with the provider's content. In another implementation, the content exchange service may prevent a low performing content network from participating in the content exchange entirely.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client” or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method of determining a differential performance metric for a content network comprising:
retrieving, from a storage device, auction data indicative of results for a plurality of content auctions won by a first content network;
calculating, by one or more processors, a first performance metric for the first content network using the auction data;
generating, by the one or more processors, differential auction data from the auction data by disregarding the participation of the first content network in the plurality of content auctions won by the first content network;
determining a second performance metric for one or more other content networks by using the differential auction data to predict results for the content auctions that would have been won by the one or more other content networks had the first content network not participated in the content auctions; and
determining a differential performance metric for the first content network by determining a difference between the first performance metric and the second performance metric.

2. The method of claim 1, wherein the first and second performance metrics are revenue metrics indicative of revenues earned by a first-party content provider.

3. The method of claim 1, wherein the first and second performance metrics are value metrics indicative of values obtained by a third-party content provider for content placements.

4. The method of claim 1, further comprising:
providing the differential performance metric for display.

5. The method of claim 1, further comprising:
comparing, by the one or more processors, the differential performance metric for the first content network to a differential performance metric for a different content network.

6. The method of claim 5, further comprising:
preventing the first content network from participating in a content auction based on the differential performance metric for the first content network.

7. The method of claim 1, wherein the first performance metric is based on a cost per click advertisement and the second performance metric is based on an impression-based advertisement.

8. A system for determining a differential performance metric for a content network comprising one or more processors operable to:
retrieve, from a storage device, auction data indicative of results for a plurality of content auctions won by a first content network;
calculate a first performance metric for the first content network using the auction data;
generate differential auction data from the auction data by disregarding the participation of the first content network in the plurality of content auctions won by the first content network;
determine a second performance metric for one or more other content networks by using the differential auction data to predict results for the content auctions that would have been won by the one or more other content networks had the first content network not participated in the content auctions; and
determine a differential performance metric for the first content network by determining a difference between the first performance metric and the second performance metric.

9. The system of claim 8, wherein the first and second performance metrics are revenue metrics indicative of revenues earned by a first-party content provider.

10. The system of claim 8, wherein the first and second performance metrics are value metrics indicative of values obtained by a third-party content provider for content placements.

11. The system of claim 8, wherein the one or more processors are operable to provide the differential performance metric for display.

12. The system of claim 8, wherein the one or more processors are operable to compare the differential performance metric for the first content network to a differential performance metric for a different content network.

13. The system of claim 12, wherein the one or more processors are operable to prevent the first content network from participating in a content auction based on the differential performance metric for the first content network.

14. The system of claim 8, wherein the first performance metric is based on a cost per click advertisement and the second performance metric is based on an impression-based advertisement.

15. A computer-readable storage medium having machine instructions stored therein that are executable by one or more processors and cause the one or more processors to perform operations comprising:
retrieving auction data indicative of results for a plurality of content auctions won by a first content network;
calculating a first performance metric for the first content network using the auction data;
generating differential auction data from the auction data by disregarding the participation of the first content network in the plurality of content auctions won by the first content network;
determining a second performance metric for one or more other content networks by using the differential auction data to predict results for the content auctions that would have been won by the one or more other content networks had the first content network not participated in the content auctions; and
determining a differential performance metric for the first content network by determining a difference between the first performance metric and the second performance metric.

16. The computer-readable storage medium of claim 15, wherein the first and second performance metrics are revenue metrics indicative of revenues earned by a first-party content provider.

17. The computer-readable storage medium of claim 15, wherein the first and second performance metrics are value metrics indicative of values obtained by a third-party content provider for content placements.

18. The computer-readable storage medium of claim 15, wherein the operations comprise:
comparing, by the one or more processors, the differential performance metric for the first content network to a differential performance metric for a different content network.

19. The computer-readable storage medium of claim 18, wherein the operations comprise:
preventing the first content network from participating in a content auction based on the differential performance metric for the first content network.

20. The computer-readable storage medium of claim 15, wherein the first performance metric is based on a cost per click advertisement and the second performance metric is based on an impression-based advertisement.
